(19) United States
(12) Patent Application Publication
(10) Pub. No.: US 2008/0235520 A1
(43) Pub. Date: Sep. 25, 2008

(54) Transportable, Configurable Data Carrier For Exchanging Data Between Electrical Devices, and Method Therefor

(75) Inventors: Joachim Becker, Jena (DE); Gerald Kraft, Furth (DE); Heinrich Thoma, Dentlein (DE)

Correspondence Address: RANKIN, HILL & CLARK LLP, 38210 Glenn Avenue, WILLOUGHBY, OH, 44094-7808, US

(73) Assignee: ELEKTRONIC THOMA GMBH, Dentlein (DE)

(21) Appl. No.: 12/066,989

(22) PCT Filed: Sep. 1, 2006
(86) PCT No.: PCT/EP2006/008561

§ 371 Date: Apr. 30, 2008

(30) Foreign Application Priority Data
Sep. 16, 2005 (DE) 10 2005 044 483.0

(51) Int. Cl. G06F 12/14; G06F 12/00; H04L 9/28

(52) U.S. Cl. 713/189; 711/115; 726/27; 711/E12.092

(57) ABSTRACT

Adequately designed transportable data carriers are used for different applications. In order to allow for individual, particularly automatically adjustable, interactive configuration and allow also inexperienced users to rapidly transfer data, the invention relates to a data carrier comprising a single interface circuit to be connected to the respective device, a data memory for temporarily storing the data fed by the respective device, input and display means for user-controlled operation and user guidance, and a control unit that is connected to the same and is provided with a program memory for executing application programs and communication functions such that an authentication process is carried out, the transfer mode (master/slave) and the direction of the data transfer are automatically detected, and the adequate transmission type/speed/protocol for downloading the data are selected according to said authentication and identification processes with the aid of the control units for configuration purposes when the data carrier is connected to the respective device, and memory areas of the data memory can be read in and out and deleted only once the authentication process has been successful.

The present invention relates to a transportable data carrier for exchanging data between electrical devices and to a method therefor according to claim 1 or 5.

The portable information media with single control and programmable hardware memory for storing and processing information are well known. Such information media are being used, for example, as credit cards, bank cards, access cards, etc. In order to improve such portable information media, which is multifunctional, adaptable and more secure against external manipulation in DE 28 58 818 C2 an information media is known in which the control is based on a microprocessor connected via address-data-channel to the programmable read/write memory and in which specific area of the programmable memory the external access is being blocked by the microprocessor and the reading and writing within the information media are free. The microprocessor has one control module, one arithmetic module, device for reading the program memory read/write, and for entering data-parallel address-data channels. Furthermore a program memory is used the contents of said program memory controls the work of the microprocessor. The control module of the microprocessor controls the serial interface for extraction and displaying the data connected to the parallel two-way address/data channel. The serial input/output interface has one gate circuit and means for converting the serial information to parallel one. At the output there is one gate circuit controlled by a signal issued by the control module of the microprocessor via cable. The reading/writing of the programmable memory is done by a address register and a data register connected to the memory and to the address/data channel. The address register and the data register are controlled by the control module via control conductors. One area of the programmable memory reading/writing stores the permanent owner's code which is being compared to the one externally entered. When the codes do not match, error information and additional information about the actions are stored in the memory. If the codes match means for storing an access code are used. The error information and the access code are stored in different storing areas, whereby any external access is denied to the first area, internal and external reading and writing operations in the information media are permitted in the second are, and only internal and external reading operations in the information media are permitted in the third area. By entering an appropriate program the microprocessor can be configured for any desired application.

In order to improve and extend the functionality of the portable data processing device through two-way dialog with the module connected to the device, in DE 31 21 466 C2 it is disclosed that the module itself contains a data microprocessor and memory. A coupling conformed by an electric conductor exchanges bidirectional and serial the data between the processors of the device and the module. The memories of the device and the module have programs for bidirectional data exchange, and the processor of the device operates by within the module memory contained executable programs. The device is mounted inside a metal or plastic enclosure—as usually used by calculators—with opening for putting the module into the device. The information and the data are entered via a keyboard which can have random number of keys, for example functional keys and the device has a display. The device and the module can also function as data transmitters and receivers, and the respective data receiver signals the respective data transmitter its standby for transfer. This is done when the receiver sets the conductor in permanent condition which can be recognized by the data transmitter. The respective data receiver signals to said respective data transmitter about transmission error by setting the conductor in a condition which can be recognized by said data transmitter and which is different from the receiving condition. The conductor accumulates commands and coded information between said respective data transmitter and receiver, as well as verifications and coded information between said respective data transmitter and receiver. Finally the device has a module which can recognize a transmitted code word enabling the module to permit access to the data or programs requested by the device.

More and more common in the practical application is the so called digital tachograph. This is due to the fact that since Aug. 5^{th} 2005 all European countries except Italy and Germany enforced EU Directive 3820/85 from 21 Dec. 1985 (Directive for control devices in road traffic, last amended on 5 Mar. 2004) prohibiting the analogous tachographs (registering in polar coordinates the speed of the vehicle, the time and the work hours of the driver). For example, a portable electronic memory is known from WO 96/31846 A1 in the form of key-holder, which has control module, storing module and a single interface circuit. The digital tachograph contains a control module, a display and output module (LCD and speaker), rewritable data memory (for control data), a power supply and an interface circuit, which can be connected to the portable electronic memory. The control data, and namely start and end of the trip are registered by a vibro-sensor reacting to the unevenness of the road and stored in the memory (64 κ-memory and 10 trips daily equals 200 days). When the memory is almost full, an indication signal is generated (tone signal) and an optional blocking device is activated. The control data is downloaded by the operator by connecting the portable electronic memory to the tachograph. The right for access is checked by the control device and then the control data is transferred to a desktop or a portable computer and the memory of the digital tachograph is reset.

The improved version of EP 0 762 339 A2 is a tachograph with electronic memory and processing of the operational data of the vehicle, which improve the control of the work time—particularly in different labour time regulations. For this purpose the tachograph contains means for detecting the condition of the vehicle and generating vehicle condition data, a real-time clock, a module for inputting the driver's data, a first processor connected to the clock, to said means for detecting the condition of the vehicle and to said input means for the driver's data for real time processing. Further a comparative memory for constant storing of the important comparative data about the vehicle (work time norms), second processor connected to the output of the first processor, the output of the comparative memory and to the module for the driver's data and real time signals. The second processor compares and processes additionally the data about the vehicle and the data about the work time. There is a memory for control data connected to the output of the second processor for storing control data about the driver. A chip or magnetic card is provided to be inserted in the data entering and reading module. This card/chip is meant to facilitate the driver and to increase the security of the operations. A service card might be useful for the technician of the vehicle for expanded access to maintenance and adjustment. In addition, cards with different levels of access could be provided for controlling bodies for old data, control data or data about the vehicle. Finally, a so called company card can be provided for extraction and storing data during work. The cards of both drivers have a read-only memory storing the data about the disconnection of the ignition, and the control data. The register can rewrite the control data to the control memory of the card and to read it. The register has temporary control memory, with input connected to the reading device of the control memory of the driver's card and output connected to the writing device. The register has controls for storing the work time data in the temporary control memory and constant writing for the time during which the card is inserted in the register. The control memory can include array of rewritable separately accessed storing areas for storing complex data including at least the sum of times and the moments of registration. Before the removal of the card, the stored data can be transferred to the control memory, thus identifying the driver. If the same driver drives another vehicle, his work time data will be registered in the card, which always contains updated balance of the work time, corresponding to the regulations. Comparable memory is provided for the work time data and for connection between them and the indications. The register is for separate registering of the control data. In addition, the comparative memory stores at least one set of comparative data about the dates of positioning, defining the territory of validity. The processor processes the data about the condition of the vehicle in accordance with the actual position of the vehicle. Together with GPS defining the zones of validity for certain work times the work time can be adjusted automatically to other local regulations. Other set of norms could be activated manually when passing a state border. In both cases the system calculates the work time for the new system and helps the driver freeing him of complex calculations and new knowledge. The adjustment of a system for secure data storage, and in particular for selective access to the areas of the control memory for reading or writing to the comparative, access devices are provided including electronic reading correction card or two cards with different access functions. The correction card has memory for storing the data from the register which provides secure storing of the evidence needed by the control bodies. Read-only memory is provided for internal (and external) checks of the data about the vehicle and its equipment. The read-only memory is connected to the input of the processor. The read-only memory and the reader of the driver's card are connected to the inputs of correlation block. The output of the correlation block is connected to the register. Thus the data stored in the read-only memory and the driver's card can be checked and verified and the result of the check can be registered. The register can have a slot for electronic driver card. The card can have memory for data about the driver's competence (eventually for transport of hazard loads or people).

A similar configuration is disclosed in EP 1 437 690 A1. Here too there is portable electronic memory and digital register with control module, registering module, rewritable memory (for storing control data), first interface, which can be connected to portable electronic memory, second interface for reading of the drivers' cards and third interface for reading the cards of the control authority (police). The portable electronic memory contains control module, memory, first and second interface, switch, 2 LCDs and independent power supply. The first interface (6-pin serial interface in accordance with RS 232 (IEEE 802.11)) can be connected to the digital register and the second interface (USB-output—serial interface) can be connected to computer. The switch of the portable memory can be set to positions Slave or Master, and the LCDs indicate the operation mode. The storage of the portable memory can be constructed as external memory (internal flash memory: programmable, power independent memory or micro-disk) or as flash memory (card). The two-side connections (6-pin connector or USB, or flash memory connector) can be protected by caps. In order to extract data from the register, the operator must perform the following:
Insert his control card in the slot of the register (third interface)
Connect the portable electronic memory to the first interface of the register
Make a connection between the register and the portable electronic memory
Switch the register on and send a command
End of the download

The protocol is based on Master/Slave—the portable electronic memory is Master, and the register is Slave. The control data can be extracted by switching the portable electronic memory to Master via the USB interface or by pulling out the flash memory and connecting a reader.

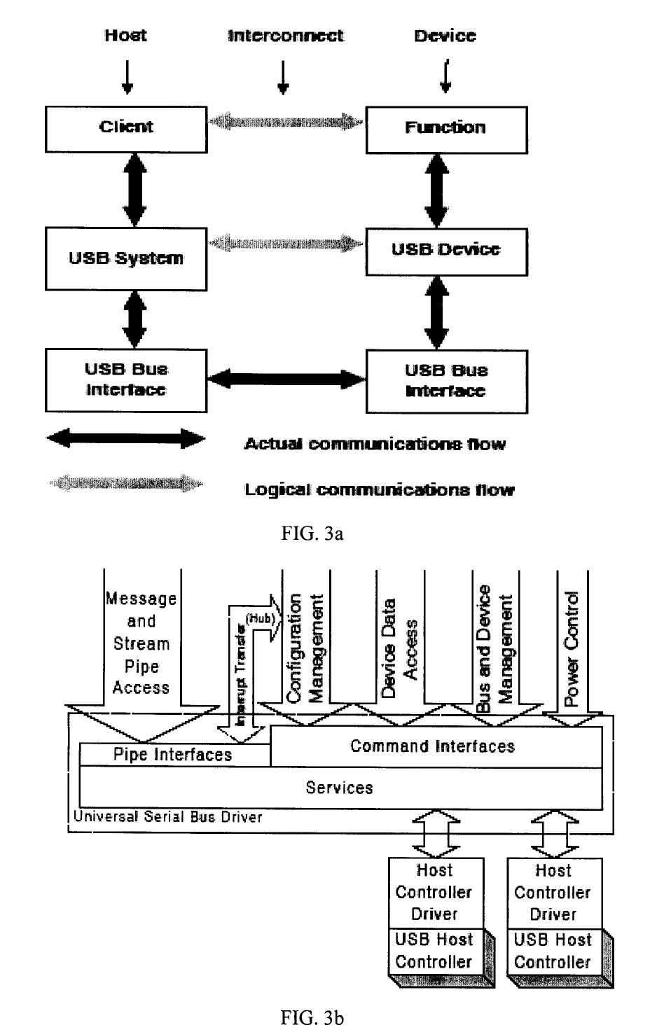

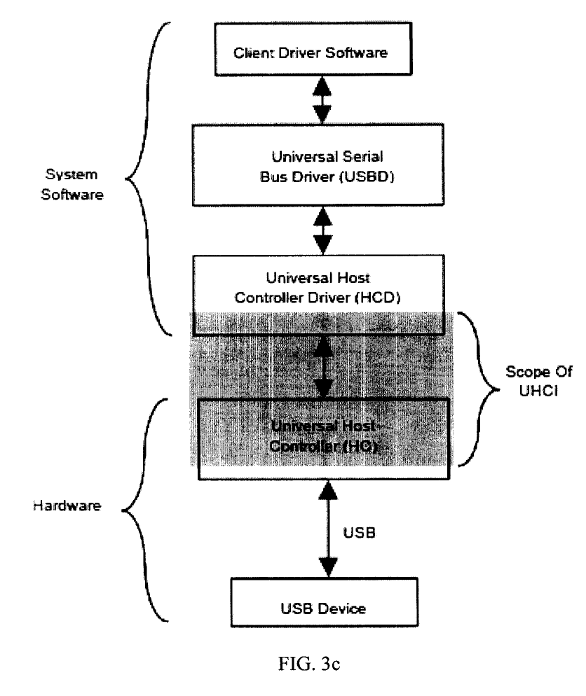

Unpublished version of DE 10 2004 029 889 A1 discloses a first end device for data exchange with at least one second device using executable apparatus drivers stored in the program memory of the first end device. The base is Universal Serial Bus On The Go (USBOTG) which is addition to the actual Universal Serial Bus Specification 2.0, which identifies the difference between various devices—data entering devices, audio devices, mass memories and communication devices. The construction of the device allows data exchange between mobile end devices (phones, Personal Digital Assistants, mass memories, printers, scanners, keyboards, Camcorder, MP3-players, etc.) eliminating the need of intermediate processor (Host PC). The end devices themselves have double role as Hosts and as peripherals. The conception USBOTG allows dynamic switching between Master and Slave (see FIG. 3a to FIG. 3b). In the specific case of company software, this is firmware which remains unchanged for the duration of the device and is stored in the hard disk (ROM, PROM, EPROM), which cannot be easily replaced. The unpublished version of DE 10 2004 029 889 A1 provides that the program memory of the first end device has area reserved for additional drivers. In case of additional drivers the limited capacity of the program memory of the first end device must be considered and the driver must be adjusted to the preset software interface in the OS of the program memory of the first end device. Thus no new registration of the first end device is needed. The adjustment of the driver is done by special interface, for example through the USB interface, directly by serial interfaces or by downloading the driver from PC or Internet via the mobile telecommunication network. The first end devices may be mobile wireless telecommunication modules, Personal Digital Assistants, cameras, printers, MP3-players, etc. Second, respectively additional end devices may be external storages, mobile phones, cameras, MP3-players, scanners, printers and keyboards for mobile phones. The transfer of the drivers is not limited to the end devices with USB outputs and can be done to other wire or wireless end devices.

Finally WO 2004/055635 A2 discloses a method for data security of the mobile phone data by which the portable memory can store the data from the SIM card (Subscriber Identity Module), needed to use the mobile phone in the Global System for Mobile Communication via the different networks. The identification of the member of the GSM network is done by identification code in the SIM card known by the switching centre (Mobile Switching Centre located in Home Location Register). The authentication process is based on comparison of the results and searches done in parallel by the SIM card and in the switching centre. During the authentication process the mobile telephone receives one random number sent by the switching centre and applies specific algorithm to this number and the identification code and calculates another number. When the results match, the authentication of user is successful. Each authentication leads to new calculation using new values, thus eliminating the manipulation by other persons. In order to secure at least the data on the SIM card and other personal data, the mobile phone subscriber shall take out, upon first form of executing WO 2004/055635 A2, the SIM card from the mobile phone, shall place the portable disks on the SIM card of the mobile phone, and by means of the keyboard and the display of the mobile phone shall download the data secured on the data carrier, shall remove it from the SIM card-bearer and then shall place back the SIM card of the mobile phone. For this purpose the data device has steering system with a programmable read-only memory (ROM), additional memory such as the Electrically erasable programmable read-only memory (EEPROM), the operative memory namely Random access memory (RAM), and an interface circuit (I/O) and contacts to connect with the power supply (Vcc, GND) of the mobile phone. A second alternative of operation of the portable data device, particularly a major-shaped casing and a button to trigger the process of data download, respectively to secure the downloaded data from overwriting and the respective indication means, there are also three different interface circuits, namely a slot for the introduction of the SIM card, an interface to host the adapter module for connecting the mobile phone, and an interface to connect a computer or a PDA (Personal Digital Assistant), or to a mobile phone in accordance with the CDMA standard, or to USB, FireWire port or Bluetooth, etc. The internal storage facility can have either different kinds of memory, or host data storage into different memory areas in order to save separately, for example, data from several different mobile phones or mobile phone subscribers. The access to these different memory/data storage areas can be secured via a password.

As shown by the foregoing description of the present state-of-the-art, there is a variety of transportable data carrier known designed to meet the requirements of different fields of application. The communication between the data carrier and the electric devices is regulated by means of specification protocols, which requires as a rule specific hardware and software components together with some expensive components particularly adapted to communication requirements. Therefore, the costs of check-up, maintenance and recording of data, for example for use with digital tachographs, are considerably high. The so-called Memory Stick (USB), well known from the world of personal computers, makes no allowance for Master operation, nor an interactive input to read the data. Likewise, there is no effective security mechanism to protect from unauthorized access to the data. Insufficiently consideration is paid to the development of an open-access system, in particular to provide easier and more secure communication mechanisms. For example, the connection and communication with the digital tachographs are performed always at a data rate of 9600 Baud; on other hand, with the USB interface (as with the subject of EP 1 437 690 A1) the interconnected devices can be power supplied through a quadrifilarly bus cable and, for example, with the version USB 2.0 the data transfer rates can reach up to 480 Mbps (see FIG. 3a-FIG. 3c). Therefore, the practice does not know procedures or portable data devices, which, in spite of being easy and simple to use, their range of application is quite variable and therefore there is possibility for restrictions of use and user groups, while ensuring individual, particularly automatically customizable, interactive communication. In particular this is important, because the data processing equipment and the accessories thereto has been for long considered a highly advanced, rapidly developing manufacture industry, which very quickly pick up improvements and simplifications and implement those.

Object of the invention is to design a portable data carrier and method therefor, to allow for individual, particularly automatically adjustable, interactive configuration and allow also inexperienced users to rapidly transfer data.

This object is solved by a portable data carrier for data exchange between electrical devices with a control unit and a memory, according to claim 1, comprising:
a single interface circuit to be connected to the respective device;
a data memory for temporarily storing the data fed by the respective device;
input and display for user-controlled operation and user guidance;
and a control unit that is connected to the same and is provided with a program memory for executing application programs and communication functions,
   such that an authentication process is carried out, the transfer mode (master/slave) and the direction of the data transfer are automatically detected, and the adequate transmission type/speed/protocol for downloading the data are selected according to said authentication and identification processes with the aid of said control units for configuration purposes when said data carrier is connected to the respective device, and memory areas of said data memory can be read in and out and deleted only once the authentication process has been successful.

This design of the transportable, configurable data carrier according to the invention, has the advantage that, due to the flexible mechanisms of communication it is easy to use in a large range of applications and system architectures in a surprisingly simple and cost-effective manner. In addition, it worth noting that even an inexperienced user can operate the transportable, configurable data carrier for exchange of data without any risk of unauthorized data access or user error.

Furthermore this object is solved by a method for data exchange between electrical devices with a control unit and a memory carried out by a portable data carrier, comprising a single interface circuit, a data memory for temporarily storing the data fed by the respective device, input and display, and a control device provided with a program memory for executing application programs and communication functions, according to claim 5, whereas for configuration purposes the control units:
an authentication process shall be carried out upon connection of said data carrier to the respective device;
an automatic detection of a transfer mode (Master/Slave) and of the direction of the data transfer shall be carried out;
a selection of the adequate transmission type/speed/protocol for downloading the data shall be carried out; and
   only once the authentication process has been successful memory areas of said data memory can be read in and out and deleted.

The method according to the invention has the advantage that the security conditions in all aspects are fulfilled, particularly by the transparent transfer of the authentication data. The development, the production and the distribution of such portable data carrier can be independently performed regardless of the specific purpose of use.

In one embodiment of this invention, in accordance with claim 2, said control unit is connected to or have a communication processor, memory management and memory access control.

The use of a communication processor gives this invention the advantage that, for example, a standard service interface (RS-232) can be made available and that the control unit is not engaged with computing power for the purpose of conducting analyses, such as the synchronization of data or parameterization of data transmission. In practice, the limitation of the requirements for the establishment of the control unit makes up for the overhead costs related to the communications processor.

For the purpose of flexible power supply is, in accordance with claim 3, a power supply connected to said interface circuit.

The flexible power supply (large supply area) is at any time adaptable to the connected device, without requiring at the same time for new dimensioning of the power supply system. For example, when using digital tachographs, the portable data device is charged on one part via the on-board power supply network 24/12V via the tachograph of the same vehicle and on the other part, via an adapter to the USB port (+5 V) of the PC/laptop.

In one embodiment of this invention, in accordance with claim 4, said communication functions and/or application programs are not fixed, but on the basis of a control unit, which is freely programmable and optimized in terms of communication functions.

This alternative method according to the invention has the advantage that the development, the production and the distribution of such control unit can be independently performed from a specific (data) bus system so that it is possible to make enhancements within the communication functions, respectively the applications, or the addition of new communication features, respectively applications, via software updates, which does not require the implementation of a new control unit and the option of two or more communication interfaces and applications can be determined by loading the software, while being accessible for fully compatible and flexible combination with it. This flexible structure of the invention control unit has significant advantages over the development through FPGAs (Field programmable gate array) programming, or parts thereof, which is a fixed wired logic. Due to the flexible command set and the associated logic functional blocks it is possible to operate, in a significantly speedier systematical manner, and to solve in parallel several independent tasks, thus achieving, independently from the protocol, high processing and transmission speed, as well as permeability in both directions.

In a preferred alternative method of the invention, in accordance with claim 6, by means of said control unit, a memory management and a memory access control, in said data memory data can be stored unique by an identifier (registration and date) and wherein only by pressing a button it is possible to select downloaded data, but it is not possible to delete the data.

This further method has the advantage that the data received from multiple devices in the portable data device, can be recorded error-free, and it allows no modification in the data content, but only exchange of data or complete deletion after downloading.

In further development of this invention, in accordance with claim 7, said display is designed as LEDs, and wherein by flashing lights at different frequencies a feedback to the user is provided concerning selected functions, download status (end of a downloaded data block) and an error message. By consultancy to the user manual, and by using LEDs it proves to be a quite simple and inexpensive way to prevent user errors. Therefore, the portable data device, as described under this invention, is extremely suitable for both inexperienced and untrained users.

In a preferred alternative method of the invention, in accordance with claim 10, data downloaded from the respective device are stored in data blocks in said data memory and wherein said memory management secures against unauthorized overwriting in said data memory, warns the user in case of the insufficient memory capacity and in case of full data memory allows no further transfer of data.

This further alternative method has the advantage that even an inexperienced user can securely operate the portable data device, as subject of this invention, and be safe from any user errors.

In the process of further development of this invention, in accordance with claim 11, for encryption and decryption of data a dynamic or a key or a rolling “encrypted container” is applied, whereby the data are grouped into a data unit and a number of grouped data units are grouped into a Container Unit, and wherein the range of encryption covers said data unit or said entire container units.

This further method according to the invention development enables—through the different procedures for data encryption and decryption—in surprisingly simple way to achieve targeted and adaptive adjustment, including to reduce the number of any repetitions that may be needed, and hence to reduce the total rate of on-block errors. According to the invention, the security of the connection, in particular the transfer of data from the direction-dependent transmission of preset variable data blocks shall be performed via such targeted and modified repetition, while taking into account that the transfer of data and security of data blocks depends also on the data content. Moreover, for the second repetition, the encryption and the decryption can be optimized to those data structures, which under the first encryption or decryption is not particularly involved, etc.

Further advantages and details may be learned from the following description of preferred designs of the invention taking into account the drawings, which show:

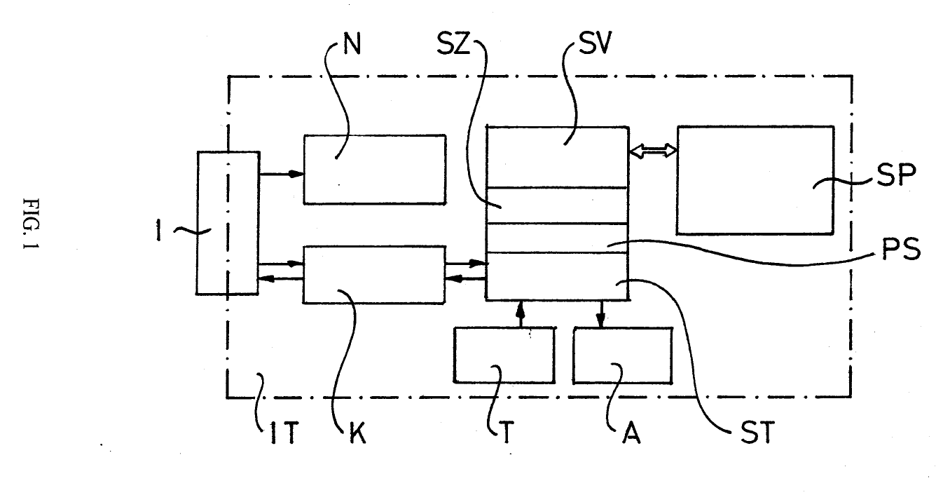

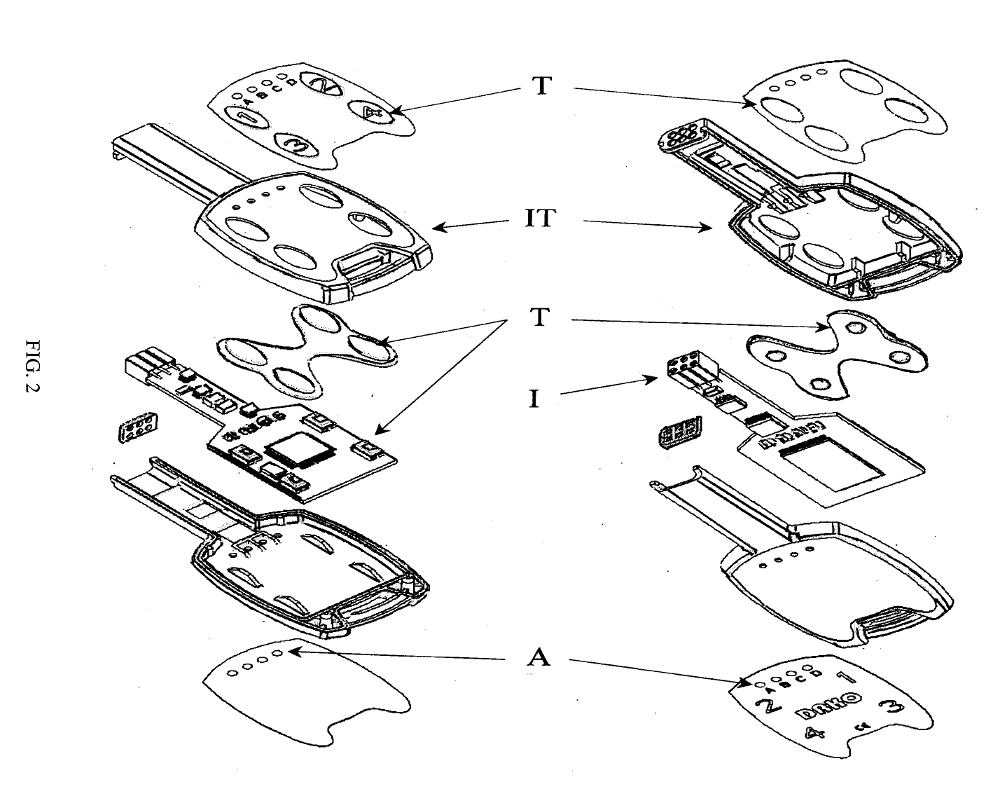

FIG. 1 the functional block diagram of a preferred embodiment of the invention;

FIG. 2 a sketch showing from the top and the bottom view a preferred embodiment of the invention concerning the portable data device; and

FIGS. 3a, 3b and 3c the interaction between the Host (PC) and the device (for example, USB stick), the USB driver framework and the scope of performance based on the example UHCI common to the state-of-the-art.

FIG. 1 shows a preferred embodiment of the invention concerning the portable, configurable data carrier IT, which enables the user to exchange data from any other device onto this portable data device, to transmit this data and to re-read and display it again on another device. Although the embodiment of the invention solution is described herein below as an exemplary use with a digital tachograph (see FIG. 2), it is allowable to apply this procedure of the portable data device also with other devices having the appropriate interfaces. It is due to the fact that the invention concept idea is based on the configuration capacity and the potential a single, error-handling device allows, and the easy adaptation to the particular circumstances and without involvement of the invention and modification of the basic concept. In comparison to the USB interface, the invention of the portable data device IT does not have universal interface and does not need pushdown storage (Stack). The cooperation between the Host (PC) and the equipment (for example, USB) at both logical and physical levels is shown on in FIG. 3a. FIG. 3b shows the structure of the software stacks under the example of drivers, whereas FIG. 3c shows the connection between the USB controller to the client, which is specific and implemented in interfaces:
UHCI (Universal Host Controller Interface)
OHCI (Open Host Controller Interface)
EHCI/Extended Host Controller Interface) USB 2.0,
   whereas based on the example of the example of UHCI the scope of action is also depicted.

Hence, the USB interface is an open interface with one USB stack, a variety of device drivers and interfaces, and one agreed USB protocol. A USB connection is always composed of a Master (PC) and a Slave (Device). In case those two Master devices are running together, for example a PC and a laptop or a PC and a PDA, the protocol will be extended. This extension is called USB OTG. After the establishment of contact, the two Master devices clarify via the protocol which can be Master and which can deal with the function of Slave.

The data device IT shown in FIG. 1 and FIG. 2 is equipped, for the exchange of data with the digital tachograph (not shown in the drawing), with a single interface circuit I, a data memory SP for temporarily storing the supplied digital tachograph data, input and display means T, A for the user-control and user interface for data exchange, and a control unit ST with programmable memory PS for executing application programs and communication functions. Furthermore, the control unit ST provides for a communication processor K, a memory management SV and a memory access control SZ, whereas these additional components can be used also separately without amending the invention concept. Finally, the flexible power supply is envisaged with power supply N associated with the interface circuit I. The tasks of the communication processor K include:
Receiving/sending data via the UART wire (Universal Asynchronous Receiver/Transmitter=universal computer hardware that translates data between parallel and serial forms);
Confirming the transfer (Parity-Modes: for example, parity checking as simple procedure to detect transmission errors, whereas a group of bits is extended with the number of “parity bits” with the corresponding assignment of an additional parity bits up to a straight or odd number);
Releasing of the main processor of I/O works;
Caching memory data to be further transferred/transmitted;
Signaling through IRQ (Interrupt Request: a hardware signal used by the devices in order to trigger the Interrupt-Service-Routine of the Host system. Triggering the IRQ, the control unit completes all momentary calculations, secures the calculation status, and deals with the priority IRQ) to the parent processor, if data are available, or data are sent successfully;
Data packages can use DMA (Direct Memory Access=direct access to the memory of a computer in the control unit, if available) for extraction and independent transfer or after receipt thereof to be stored in the memory for further operation.

The realization of the communication processor K is feasible as an external or an internal unit (see FIG. 1 as external and FIG. 2 as an internal unit).

For theft protection, the portable IT data device has a clear and unique serial number and its fixed operating program can be expanded and replaced as modules. The control unit ST processes the data in Hammingcode with a Hamming distance of ≧1, predominantly 4, and may also include encryption and decryption of the data. For the purpose of data transmission there are robust method for data security. A preferred method for protection is a CRC method for data security (cyclic redundancy check=cyclic CRC), for example CRC-32, where the information words to be transmitted are divided by means of a polynomial word and the rest of the division is transferable as a mark of control. On the part of receiving the accepted the information words undergo the same division and control is exerted whether the results match the marks of control.

The data from the digital tachograph is received under simple operation, as briefly described below:
After inserting the portable data device IT into the socket of the digital tachograph it is possible that by means of button T to selection downloadable input data units. This is beneficial in order to reduce the download time to a minimum. In this case of application, the data can be as follows: speed, activities over a certain period of time and other events recorded in the digital tachograph data units;
Via four LEDs A (single indication) a feedback is provided to the users concerns the selected function (Download unit, units), the data download status (end of unit download), and a message of general error. This is achievable via lightning of LEDs and through different LED frequencies;
In the data memory SP stored data are identified with an ID code (Registration and Date). Deletion of the data from the portable data device IT is not possible;
The user manual and the fault tolerance provided by the software of the control unit ST prevents any further user error.

The reading of the portable data device IT is carried out via an adapter card, for example on the PC, as briefly described below:
Through a PC software (not standard) the entire contents or even individual units of the data memory SP can be requested and controlled via an adapter card;
Deletion of transmitted memory units, deletion of unnecessary data units from the data memory SP is possible only from the PC to enable the easy provision of external services;
The acquiring PC software makes no changes to the data content. The data content can be used to control/analysis in a concise manner.

For optimal data transmission the following measures are provided for in compliance with this invention:
Automatic detection of the transfer mode (Master/Slave) and selection of adequate transmission type/speed/protocol;
The data are stored in secure packages;
The communication protocols include commands to negotiate the best transmission speed.

To ensure the data security of transported data and to ensure against unauthorized access by third persons the following measures are provided for in compliance with this invention:
The data will be stored along with error protection and error correction methods;
The access to data from the outside is only possible by means of an electronic code (authentication);
The Software Download can be successful only after successful authentication;
The software stored in the programmable memory PS of the portable data device IT ensures that the data is transported but remain unchanged;
Deletion of data in the data memory SP of the portable data device IT is allowable only after successful authentication.

In order that the area of application of the portable data device, as subject of this invention, to extend as much as possible, in compliance with the invention it is possible to accept data from several digital tachographs. For this purpose the memory management SV has the following functions:
The data are recorded in the data memory SP according to their source of origin;
The data reading specifically allows this data to be postponed in the data storage SP.
The memory management SV prevents any accidental overwriting during the data receipt operation in the digital tachograph;
The memory management SV warns the user of insufficient memory capacity for storage and in the case of full memory SP does not allow further data acceptance.

Furthermore, in accordance with the invention, through a special PC software of the current program, the portable data device cam at any time adapt to or revise completely its operational mode to meet the IT needs of the users or the groups of users. In particular, the software of the portable data device can be modularly expanded or replaced, whereas the portable data device is identifiable through a unique serial number, which can only be set by the manufacturer. The serial number of the portable data device is permanently stored with the manufacturer (ID-theft protection). For encryption and decryption of data, a dynamic key or an “encrypted container” can be used. The data are preferably grouped into Data UniT (according to their designation), whereas several Data Units can be grouped together to form Container Unit. In order to ensure the security and confidentiality of these Data Units and Container Units, they shall be transmitted, recorded and encoded. The range of encryption can be on Data Unit or on entire Container Units (containing different data with different level of importance). The latter procedure has the advantage of fast encryption, and its disadvantage is that the entire Container Unit needs to be deciphered, even if only certain data areas required. For optimal data transmission invention are the following measures:
Automatic detection of the transfer modules (Master/Slave) and selection of the appropriate transmission/speed protocol. The data are stored in secure packages.
The communication protocols include commands to negotiate the best transmission speed.

To ensure the data security of transported data and to ensure against unauthorized access by third persons the following measures are provided for in compliance with this invention:
The data will be stored along with security and anti-error measures;
The access to data from the outside is only possible by means of an electronic code (authentication);
The Software Download can be successful only after successful authentication;
The software programmable memory PS of the portable IT data device ensures that the data is transported but remain unchanged;
Deletion of data in the data storage SP of the portable IT data device is allowable only after successful authentication

In order that the area of application of the portable data device, as subject of this invention, to extend as much as possible, in compliance with the invention it is possible to accept data from several digital tachographs. For this purpose the memory management SV has the following functions:
The data are recorded uniquely in the data memory SP according to their source of origin;
The data reading specifically allows this data to be postponed in the data memory SP;
The memory management SV prevents any accidental overwriting during the data receipt operation in the digital tachograph;
The memory management SV warns the user of insufficient memory capacity for storage and in the case of full data memory SP does not allow further data acceptance.

Furthermore, in accordance with the invention, through a special PC software of the current program, the portable data device IT can at any time adapt to or revise completely its operational mode to meet the device IT needs of the users or the groups of users. In particular, the software of the portable data device can be modularly expanded or replaced, whereas the portable data device IT is identifiable through a unique serial number, which can only be set by the manufacturer. The serial number of the portable data device IT is permanently stored with the manufacturer (ID-theft protection). For encryption and decryption of data, a dynamic key or an “encrypted container” can be used. The data are preferably grouped into Data Unit (according to their designation), whereas several Data Units can be grouped together to form Container Unit. In order to ensure the security and confidentiality of these Data Units and Container Units, they shall be transmitted, recorded and encoded. The range of encryption can be on Data Unit or on entire Container Units (containing different data with different level of importance). The latter procedure is the advantage of fast encryption of disadvantage that the entire container unit to be deciphered, even if only certain data areas required. Encryption methods and procedures can be both “strict” codes and methods with “rolling” codes. “Rolling” codes mean that they are valid for application only over a certain period of time and then they need to be re-negotiated, whereas the other party should be always a step behind.

In practice, when using digital tachographs the portable data device with input socket is about 7 cm long and nearly 2 cm wide. The mechanics of the interface is prepared for tachographs, whereas the four SMD LEDs are located on both sides of the conductor plate, in order to ensure good readability when plugging into the digital tachograph (four different positions 90°). The adapter has the same interface as the tachograph to open more space for the small portable data device. According to the invention, the portable IT data device has flexible power supply (large range of supply). On one side, it is charged via the on-board 24/12V network through the tachograph from the vehicle adapter, while on the other hand it runs through the adapter of the portable IT data device from the USB port (+5 V) on the PC.

The design of the portable data device IT according to the invention as described herein above is characterized largely with flexible configuration and as a whole meet the following requirements:
Minimal size and weight (for a pocket or a keychain);
Robust and sustainable design;
A single interface for different baud rates (adaptive baud rate);
Its applications are variable in shape via downloadable software;
Feasible data exchange depending on the task in Master or Slave mode;
User interface available;
Minimal keyboard and display (LED) for easy operation;
It supports different communication protocols for data transfer to the respective record targets;
It allows for a mode of operation n-to-m (n-data sources, m-data exhaustion);
It supports the data management and the management in mode n-to-m;
It allows for encrypted data output;
Data contents of several devices are error-free recorded on the stick;
Prevention of accidental deletion while operating the DATA stick is ensured via the respective software;
Indication of full data memory in case that memory space is available only for a completed data tachograph;
No change in data content is possible (pure transport).

With the portable data device IT, which is subject of this invention, the data collected on the portable data device IT via its Master function are redirected to the memory SD, so that the data is protected from unauthorized access. In order to read it the portable data device IT is connected to the adapter and to the Slave and then it can be accessed through a program with the appropriate configuration. Through the same data transfer process, in Slave mode, the operating software of the portable data device IT can also change. For example, during the initial commissioning the portable data device IT can adopt a specific function by pressing the button T. In order to enable, according to the number and/or duration of operations of the input function, the button T to double the number of different control commands it is possible to change/update the PC operating software of the portable data device IT. So when the user connect the portable data device IT to the device operating in dialogue mode between the control devices, it is possible to carry out automatic configuration of the portable data device IT interface along with the procedural steps of authorization, automatic detection of the transfer mode (Master/Slave), including the data transfer device and, depending on it selection is made on the relevant transmission/speed protocol for the downloading of data. Due to the configurability on one side in the case of errors, a quick correction is possible whereby the portable data device IT is setting in the loading condition, and on the other side a wide variety of application is possible. For example, during authentication of the portable data device IT it is possible to use computer (connection to the USB interface, and automatic encryption of data, so that to eliminate the input of a password), or in the home banking interface HBCI, while downloading data from various cash registers (move from one cash register to another) or for the purpose of inventory placement and subsequent analysis, or for the security personnel in relation to the electronic card-watches and for the authentication with the access control systems.

In a further design of the invention the insertion of a control device card (police) in the digital tachograph can be eliminated, whereas the required data and the programmable memory functions in the PS are stored; the communication functions and applications are not preliminarily fixed, but are rather based on a freely programmable and communications functions ST in order to implement extensions or entirely new applications by software update, and the security of data can be checked up for correctness under the method Reed-Solomon (used for memory data or data transmissions), among others.

1. Portable data carrier (IT) for data exchange between electrical devices with a control unit and a memory, comprising:
a single interface circuit (I) to be connected to the respective device;
a data memory (SP) for temporarily storing the data fed by the respective device;
input and display (T, A) for user-controlled operation and user guidance;
and a control unit (ST) that is connected to the same and is provided with a program memory (PS) for executing application programs and communication functions,
such that an authentication process is carried out, the transfer mode (master/slave) and the direction of the data transfer are automatically detected, and the adequate transmission type/speed/protocol for downloading the data are selected according to said authentication and identification processes with the aid of said control units (ST) for configuration purposes when said data carrier (IT) is connected to the respective device, and memory areas of said data memory (SP) can be read in and out and deleted only once the authentication process has been successful.

2. Data carrier according to claim 1, wherein said control unit (ST) is connected to or have a communication processor (K), memory management (SV) and memory access control (SZ).

3. Data carrier according to claim 1, wherein for the purpose of flexible power supply a power supply (N) is connected to said interface circuit (I).

4. Data carrier according to claim 2, wherein said communication functions and/or application programs are not fixed, but on the basis of a control unit (ST), which is freely programmable and optimized in terms of communication functions.

5. Method for data exchange between electrical devices with a control unit and a memory carried out by a portable data carrier (IT), comprising a single interface circuit (I), a data memory (SP) for temporarily storing the data fed by the respective device, input and display (T, A), and a control device (ST) provided with a program memory (PS) for executing application programs and communication functions, whereas for configuration purposes the control units (ST):
an authentication process shall be carried out upon connection of said data carrier (IT) to the respective device;
an automatic detection of a transfer mode (Master/Slave) and of the direction of the data transfer shall be carried out;
a selection of the adequate transmission type/speed/protocol for downloading the data shall be carried out; and
only once the authentication process has been successful memory areas of said data memory (SP) can be read in and out and deleted.

6. Method according to claim 5, wherein by means of said control unit (ST), a memory management (SV) and a memory access control (SZ), in said data memory (SP) data can be stored unique by an identifier (registration and date) and wherein only by pressing a button (T) it is possible to select downloaded data, but it is not possible to delete the data.

7. Method according to claim 5, wherein said display (A) is designed as LEDs, and wherein by flashing lights at different frequencies a feedback to the user is provided concerning selected functions, download status (end of a downloaded data block) and an error message.

8. Method according to claim 5, wherein for anti-theft protection of said data carrier (IT) a unique serial number is assigned, and wherein an operating program of said data carrier (IT) can be modular expanded or exchanged.

9. Method according to claim 5, wherein said control unit (ST) processes the data stored in said data memory (SP) in Hamming-code at a distance of ≧1 and performs the data encryption and decryption, and wherein for data transfer a robust method for data security is used, in particular, a CRC method for data security (cyclic redundancy check=cyclic CRC).

10. Method according to claim 5, wherein data downloaded from the respective device are stored in data blocks in said data memory (SP) and wherein said memory management (SV) secures against unauthorized overwriting in said data memory (SP), warns the user in case of the insufficient memory capacity and in case of full data memory (SP) allows no further transfer of data.

11. Method according to claim 5, wherein for encryption and decryption of data a dynamic or a key or a rolling “encrypted container” is applied, whereby the data are grouped into a data unit and a number of grouped data units are grouped into a Container Unit, and wherein the range of encryption covers said data unit or said entire container units.
